(19) United States
(12) Patent Application Publication
(10) Pub. No.: US 2009/0284487 A1
(43) Pub. Date: Nov. 19, 2009

(54) TOUCH PANEL AND INPUT DEVICE USING SAME

(76) Inventors: Akira Nakanishi, Fukui (JP); Shigeyuki Fujii, Fukui (JP)

Correspondence Address: WENDEROTH, LIND & PONACK L.L.P., 1030 15th Street, N.W., Suite 400 East, Washington, DC, 20005-1503, US

(21) Appl. No.: 12/430,343

(22) Filed: Apr. 27, 2009

(30) Foreign Application Priority Data
May 16, 2008 (JP) 2008-129389

(51) Int. Cl. G06F 3/041

(52) U.S. Cl. 345/173

(57) ABSTRACT

A touch panel including a top substrate provided with an upper conductive layer formed on a lower surface thereof, a bottom substrate provided with a lower conductive layer formed on an upper surface thereof in a position confronting the upper conductive layer with a predetermined space, and a spacer of a frame-like shape formed at a periphery of at least one of the top substrate and the bottom substrate, and formed therebetween, wherein the touch panel further has a decorative sheet disposed on an upper surface of the top substrate so that a peripheral edge of the decorative sheet protrudes outward beyond the periphery of the top substrate.

### FIELD OF THE INVENTION

The present invention relates to touch panels used mainly for operating a variety of input devices, and also to input devices using the same.

### BACKGROUND OF THE INVENTION

With the advancement in recent years toward greater functionality and versatility of input devices of various types for use in mobile phones, car navigation systems and the like, many apparatuses are now equipped with optically transparent touch panels mounted to front plates of display devices such as liquid crystal displays. On the growing use is a type of input devices that allow users to press touch panels with a finger, a pen or the like medium to select any of functions on the input devices while visually checking screens on the display devices located behind the see-through touch panels.

Japanese Patent Unexamined Publication, No. 2003-280800, for instance, discloses a conventional touch panel of such type, description of which is now provided with reference to FIG. 7. The drawing shown in this figure is enlarged in the direction of thickness to make the structures easily understandable.

FIG. 7 is a sectional view of the conventional touch panel. In FIG. 7, top substrate 1 and bottom substrate 2 are optically transparent substrates. Top substrate 1 is provided with optically transparent upper conductive layer 3 of such a material as indium tin oxide formed on a lower surface, and bottom substrate 2 is also provided with optically transparent lower conductive layer 4 in a similar fashion on an upper surface thereof.

There are a plurality of dot spacers (not shown) formed of an insulation resin on the surface of lower conductive layer 4 at regular intervals. In addition, a pair of upper electrodes 6A and 6B are formed at both sides of upper conductive layer 3, and a pair of lower electrodes (not shown) are formed at both sides of lower conductive layer 4 in a direction orthogonal to upper electrodes 6A and 6B.

Spacer 8 formed in generally a frame-like shape is provided around the periphery of a space between top substrate 1 and bottom substrate 2. Top substrate 1 and bottom substrate 2 are bonded at their peripheries with an adhesive layer (not shown) coated on one or both of upper and lower surfaces of spacer 8 so as to make upper conductive layer 3 and lower conductive layer 4 confront each other with a predetermined space. The touch panel is thus completed.

The touch panel constructed as above is attached to frame 10 of the input device having aesthetic decorations, markings of a type number of the input device, etc. in a manner that an upper peripheral surface of touch panel is brought into contact to a lower surface of frame window section 10A.

The pairs of upper electrodes and lower electrodes are connected to an electronic circuit (not shown) of the input device through a flexible printed wiring board (not shown) comprised of wiring conductors made of copper foils covered with an insulation film.

In the above structure, when a user presses the upper surface of top substrate 1 with a finger, a pen or the like medium while visually checking a screen on the display device behind the touch panel, top substrate 1 deforms and causes upper conductive layer 3 to come in contact with lower conductive layer 4 at the position being pressed.

A voltage is applied sequentially from the electronic circuit to the upper electrodes and the lower electrodes, and the electronic circuit detects the position being pressed according to a voltage ratio between these electrodes to make switching operation of the various functions in the input device.

When the user presses any portion in the center area of top substrate 1, it causes top substrate 1 to deform generally uniformly in all directions to make upper conductive layer 3 come in contact with lower conductive layer 4. However, if the user presses a portion near the right side of top substrate 1 as shown by an arrow A, a large bending force is exerted on an area at the right side of top substrate 1 adjacent to an inner edge of spacer 8.

When wiping the touch panel clean, for instance, it is conceivable that the user tends to wipe hard in a manner to trace along the side corners of frame window section 10A since dust is apt to collect in these corners of frame window section 10A. When such practice is repeated, a large force exerted upon these areas of top substrate 1 and upper conductive layer 3 causes cracks and fractures in upper conductive layer 3 on the lower surface of top substrate 1, which can lead to instability in the electrical contact between upper conductive layer 3 and lower conductive layer 4.

In certain instances, therefore, spacer 8 may be formed of a material having a low elasticity and easily deformable property such as an acrylic or the like insulation resin containing air bubbles dispersed therein. In this case, a portion of spacer 8 can deform when a large depressing force is applied in the area adjacent to the inner edge of spacer 8, thereby allowing top substrate 1 to deform elasticity to prevent lower conductive layer 3 on the lower surface from being cracked of fractured.

The above structure still has a problem, however, that materials suitable for spacer 8 are limited, and costs of the materials and processing for manufacturing the touch panel became rather expensive.

### SUMMARY OF THE INVENTION

A touch panel of the present invention comprises a top substrate provided with an upper conductive layer formed on a lower surface thereof, a bottom substrate provided with a lower conductive layer formed on an upper surface thereof in a position confronting the upper conductive layer with a predetermined space, and a spacer of a frame-like shape formed at a periphery of one of the top substrate and the bottom substrate, and formed therebetween, wherein the touch panel further comprises a decorative sheet disposed on an upper surface of the top substrate, the decorative sheet having a peripheral edge protruding outward beyond the periphery of the top substrate.

Since the decorative sheet is formed thinner than that of a conventional frame window section, it can virtually eliminate a difference in level throughout an operating area on the upper surface when the touch panel is attached to the front face of an input device. The present invention can thus provide the touch panel featuring high stability in making electrical contact in the end use without requiring any special material having a low elasticity to form the spacer.

### BRIEF DESCRIPTION OF THE DRAWINGS

FIG. 1 is a sectional view of a touch panel according to one exemplary embodiment of the present invention;

FIG. 2 is an exploded perspective view of the touch panel;

FIG. 3 is a top view of the touch panel;

FIG. 4 is a sectional view of a touch panel according to another exemplary embodiment of the present invention;

FIG. 5 is a top view of a touch panel according to still another exemplary embodiment of the present invention;

FIG. 6 is a sectional view of a touch panel according to yet another exemplary embodiment of the present invention; and

FIG. 7 is a sectional view of a conventional touch panel.

### DETAILED DESCRIPTION OF PREFERRED EMBODIMENTS

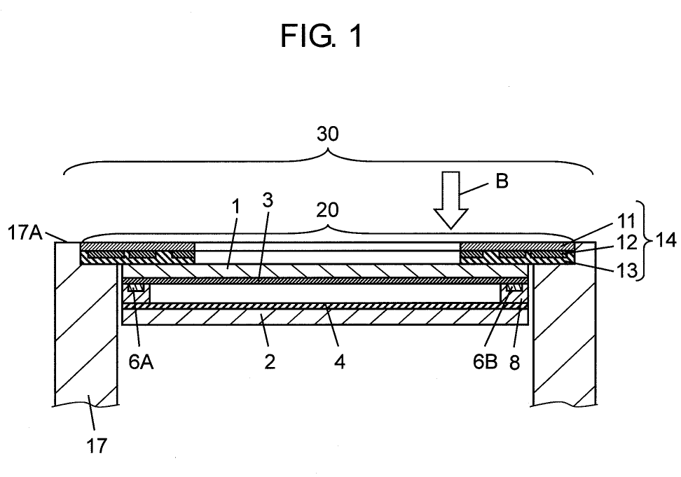

Description is provided hereinafter of exemplary embodiments of the present invention with reference to FIG. 1 through FIG. 6.

The sectional views shown in these figures are enlarged in the direction of thickness to help understand the structures easily.

In addition, like reference marks are used throughout to designate like structural components as those illustrated in the background art, and their descriptions will be abbreviated.

### Exemplary Embodiments

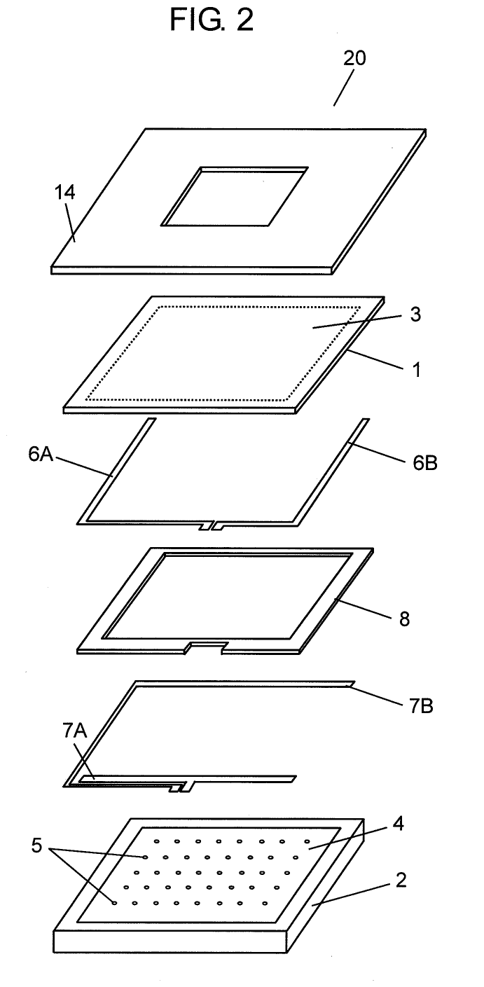

FIG. 1 is a sectional view of a touch panel according to one exemplary embodiment of the present invention, and FIG. 2 is an exploded perspective view of the touch panel. In FIGS. 1 and 2, top substrate 1 is an optically transparent substrate of a material such as polyether sulfone, polycarbonate, glass and the like. Bottom substrate 2 is also an optically transparent substrate of a material such as glass, acrylic, polycarbonate and the like. Top substrate 1 is provided with optically transparent upper conductive layer 3 of a material such as indium tin oxide and tin oxide formed on a lower surface thereof by such method as sputtering, and bottom substrate 2 is also provided with optically transparent lower conductive layer 4 on an upper surface thereof in the similar manner.

There are a plurality of dot spacers 5 formed of an insulation resin such as epoxy and silicon on the upper surface of lower conductive layer 4 at regular intervals. In addition, a pair of upper electrodes 6A and 6B are formed at both sides of upper conductive layer 3 with silver, carbon or the like material, and a pair of lower electrodes 7A and 7B are formed at both sides of lower conductive layer 4 in a direction orthogonal to upper electrodes 6A and 6B.

Spacer 8 made of a material such as polyester and epoxy is formed into generally a frame-like shape around the periphery of a space between top substrate 1 and bottom substrate 2. Top substrate 1 and bottom substrate 2 are bonded at their peripheries with an adhesive layer of acrylic, rubber or the like material (not shown) coated on one or both of front and lower surfaces of spacer 8 so as to make upper conductive layer 3 and lower conductive layer 4 confront each other with a predetermined space between 5 μm and 100 μm, and touch panel 20 is thus completed.

Front film 11 comprises a transparent film of polyethylene terephthalate, polycarbonate or the like material. Front film 11 is provided with a decorative design including characters and figures painted on its lower surface with color inks or the like agent to form decoration layer 12.

Front film 11 is also provided with adhesive layer 13 of acrylic, rubber or the like material coated on the lower surface so that a combination of front film 11, decoration layer 12 and adhesive layer 13 constitute decorative sheet 14.

Decorative sheet 14 has generally a frame-like shape when viewed from the above, and it is bonded to the upper surface of top substrate 1 with adhesive layer 13. Decorative sheet 14 has its inner edge extending inward beyond that of spacer 8 so that spacer 8 is not visible from the above. In addition, a peripheral edge of decorative sheet 14 protrudes outward beyond the periphery of top substrate 1.

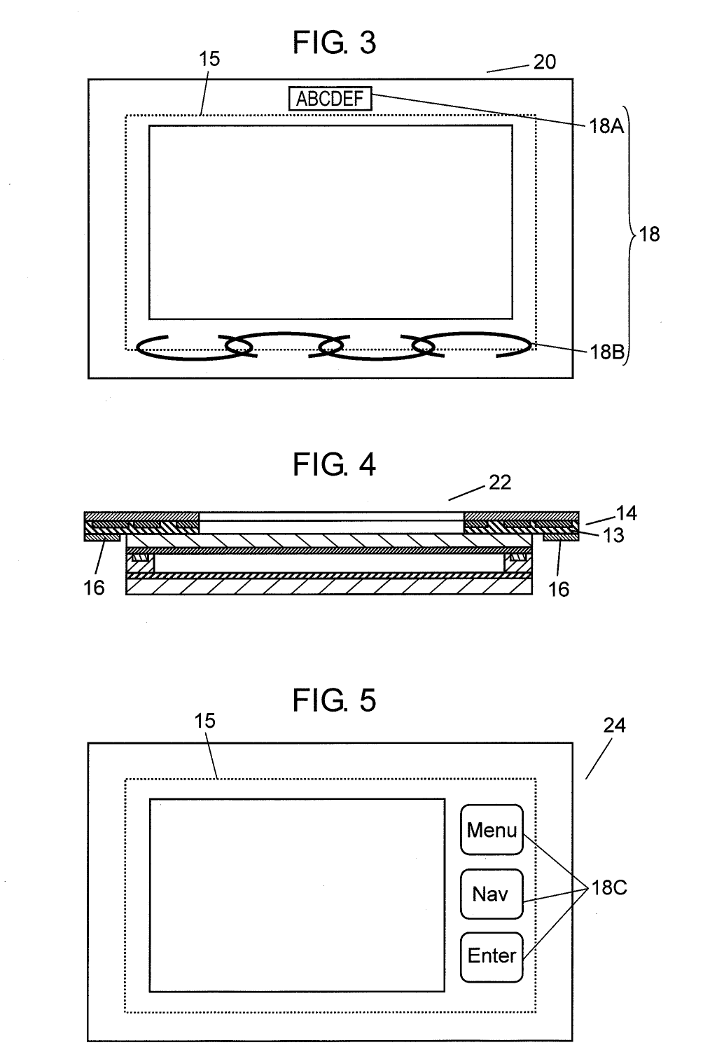

FIG. 3 is a top view of the touch panel according to this exemplary embodiment of the invention. An area surrounded by a dotted line behind decorative sheet 14 in FIG. 3 represents operating area 15 bounded by the inner edge of spacer 8, and it is the operational portion of touch panel 20.

There is decorative design 18 including, for example, characters 18A marked on the top side of operating area 15 to indicate a manufacturer's name, etc. of the input device and decorative pattern 18B on the bottom side in an area partially overlapping with operating area 15.

Touch panel 20 constructed as illustrated above is disposed on a front face of a display device such as a liquid crystal display. Frame 17 of input device 30 may be so formed, for example, that its front face 17A has a recess of a depth corresponding to a thickness of decorative sheet 14, and the peripheral edge of decorative sheet 14 protruding beyond the periphery of top substrate 1 is placed in the recess and bonded by adhesive layer 13 to the recessed front face of input device 30, as shown in FIG. 1. In other words, input device 30 according to this exemplary embodiment of the invention comprises touch panel 20 having decorative sheet 14 bonded to front face 17A of frame 17.

The input device is assembled in the manner as described to eliminate a difference in level on the boundary between the peripheral edge of decorative sheet 14 and front face 17A of frame 17 so that the upper surface of the input device can be wiped clean without pressing the area around the peripheral edge of decorative sheet 14.

Upper electrodes 6A and 6B and lower electrodes 7A and 7B of touch panel 20 in FIG. 2 have their side edges coated with an anisotropic conductive paste of an insulation resin containing conductive particles dispersed therein. Upper electrodes 6A and 6B and lower electrodes 7A and 7B are then connected via the anisotropic conductive paste to a flexible printed wiring board (not shown) comprised of wiring conductors made of copper foils covered with an insulation film. The pairs of upper electrodes 6A and 6B and lower electrodes 7A and 7B are thus connected with an electronic circuit (not shown) disposed inside the input device through the flexible printed wiring board.

In the above structure, when a user presses the upper surface of top substrate 1 with a finger, a pen or the like medium while visually checking a screen on the display device behind touch panel 20, top substrate 1 deforms and causes upper conductive layer 3 to come in contact with lower conductive layer 4 at the position being pressed.

A voltage is hence applied sequentially from the electronic circuit to upper electrodes 6A and 6B and lower electrodes 7A and 7B, and the electronic circuit detects the position being pressed according to a voltage ratio between these electrodes to perform switching operation of various functions in the input device.

When the user presses any portion in the center area of top substrate 1 in FIG. 1, it causes top substrate 1 to deform generally uniformly in all directions to make upper conductive layer 3 come in contact with lower conductive layer 4, so as not to causes any fracture or crack in upper conductive layer 3 and lower conductive layer 4. Even when the user presses a portion near the right side of top substrate 1 as shown by an arrow B, deformation of top substrate 1 is unlikely to exert a large bending force on upper conductive layer 3 since the inner edge of decorative sheet 14 is located inward from the inner edge of spacer 8, thereby causing no fracture or crack in upper conductive layer 3 and lower conductive layer 4.

In addition, the user can carry out the task of wiping the upper surface of touch panel 20 to remove dust without being caught on the frame-shaped inner edge of decorative sheet 14 since decorative sheet 14 merely has a thickness of several hundreds micrometers.

Accordingly, this structure prevents the excessive force from being exerted on the periphery of top substrate 1 and upper conductive layer 3, thereby providing touch panel 20 with high stability in making electrical contact between upper conductive layer 3 and lower conductive layer 4.

FIG. 4 is a sectional view of a touch panel according to another exemplary embodiment of the present invention. When touch panel 22 is stored or transported, it is a common practice to put release liner 16 on a lower surface of the adhesive layer 13 of decorative sheet 14 protruding from top substrate 1 as shown in FIG. 4. Release liner 16 prevents adhesive layer 13 from being exposed to the air and resulting in deterioration. Release liner 16 is removed when touch panel 22 is attached to a front face of the input device.

FIG. 5 is a top view of a touch panel according to still another exemplary embodiment of the invention. In the above embodiment, decorative sheet 14 was described as a component provided with decorative design 18 including the characters representing the manufacturer's name, decorative pattern and the like. However, decorative sheet 14 may instead include function marks 18C comprising characters such as “Menu” and “Enter”, arrows such as “→” and “←” in boxes, or the like symbols as shown in FIG. 5 to indicate positions to be pressed inside the operating area 15 so as to make it function as switches.

In other words, decorative sheet 14 can be used for the purpose of providing certain operational functions, such that when the user presses a given position on touch panel 24, top substrate 1 deforms to cause upper conductive layer 3 to come in contact with lower conductive layer 4, and the electronic circuit detects the position being pressed and carries out the switching function.

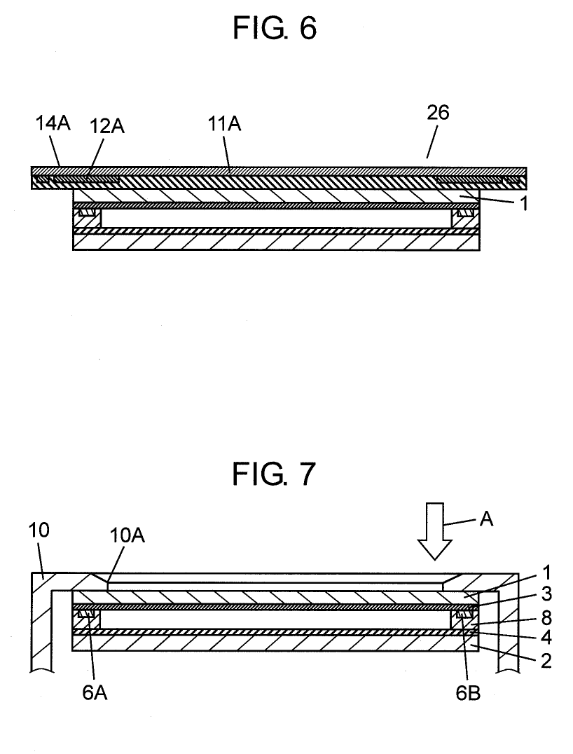

FIG. 6 is a sectional view of a touch panel according to yet another exemplary embodiment of the invention. Although decorative sheet 14 was described in the above embodiment as having generally the frame-like shape when viewed from the above, the present invention should not be considered as being restricted by the shape illustrated above. In other words, touch panel 26 may be provided with decorative sheet 14A of a shape covering the entire surface of top substrate 1 as shown in the sectional view of FIG. 6, instead of the frame-like shape having the opening in the center area.

Decoration layer 12A shown here has a decorative design including characters and figures painted on a lower surface of transparent front film 11A with inks or the like agent. Since decorative sheet 14A covering top substrate 1 can protect top substrate 1 from being damaged, it can improve the durability.

In addition, any of decorative sheets 14 and 14A may be provided with a film affixed thereto, the film having its upper surface treated with an antiglare process or antireflection process to form fine asperities to avoid reflection of the extraneous light to help improve visibility of the display device such as a liquid crystal display disposed behind the touch panel.

According to this exemplary embodiment of the present invention as illustrated, the touch panel comprises the decorative sheet disposed on top substrate 1 in a manner that the peripheral edge protrudes outward from top substrate 1. The present invention can thus provide the touch panel and the input device using the touch panel that feature high stability in making electrical contact in the end use without requiring any special material having a low elasticity to form the spacer, since it can virtually eliminate a difference in level throughout the upper surface of the input device when the touch panel is attached thereto.

What is claimed is:

1. A touch panel comprising:
a top substrate provided with an upper conductive layer formed on a lower surface thereof;
a bottom substrate provided with a lower conductive layer formed on an upper surface thereof in a position confronting the upper conductive layer with a predetermined space;
a spacer of a frame-like shape formed at a periphery of at least one of the top substrate and the bottom substrate, and formed therebetween; and
a decorative sheet disposed on an upper surface of the top substrate, the decorative sheet having a peripheral edge protruding outward beyond the periphery of the top substrate.

2. An input device comprising:
the touch panel of claim 1,
wherein the decorative sheet is bonded to a front face of the frame.
